(19) United States
(12) Patent Application Publication
(10) Pub. No.: US 2013/0232576 A1
(43) Pub. Date: Sep. 5, 2013

(54) SYSTEMS AND METHODS FOR CYBER-THREAT DETECTION

(71) Applicant: VINSULA, INC., Seattle, WA (US)

(72) Inventors: Karolos Karnikis, Edmonds, WA (US); Erick Thompson, Renton, WA (US); Ivaylo Ivanov, Normanhurst (AU); John M. Graham, Seattle, WA (US); Jason M. Hickey, Seattle, WA (US)

(73) Assignee: VINSULA, INC., Seattle, WA (US)

(21) Appl. No.: 13/679,649

(22) Filed: Nov. 16, 2012

Related U.S. Application Data
(60) Provisional application No. 61/561,708, filed on Nov. 18, 2011.

(51) Int. Cl. G06F 21/56

(52) U.S. Cl. CPC G06F 21/56
USPC 726/24

(57) ABSTRACT

Disclosed herein are systems and methods relating generally to computer system security and more specifically to scalable cyber-threat detection systems and methods that systematically and automatically execute and monitor code within a secure isolated environment to automatically identify and filter out malicious code so that it is not executed on a live system.

### CROSS REFERENCE TO RELATED APPLICATIONS

This application claims the benefit, under 35 U.S.C. §119(e), of U.S. provisional patent application Nos. 61/561,708, filed Nov. 18, 2011, entitled “SYSTEMS AND METHODS FOR CYBER-THREAT DETECTION.”

### TECHNICAL FIELD

Disclosed herein are systems and methods relating generally to computer system security and more specifically to scalable cyber-threat detection systems and methods that systematically and automatically execute and monitor code within a secure isolated environment to automatically identify and filter out malicious code so that it is not executed on an end user's system.

### BACKGROUND

Computer viruses and malware attacks are a common problem faced by computer users. Web, email and instant messenger software clients are some of the most frequent points of entry for these types of attacks. Often, malware is embedded in a file attached to or link referenced in an email or instant message which tricks the user into opening the file, allowing the malicious code to execute and propagate on the user's system or network. When executed, the malicious code may be able to exploit vulnerabilities in the executing software to gain the access and control necessary to perform certain malicious actions. Examples of such malicious actions include modifying files on the user's system, relaying information obtained from the user's system back to the attacker, and accessing the user's email system to send the malicious file to addresses found within the user's contact list.

Recent developments in computer virus and malware technology pose a serious threat not only to individual users, but also to any organization's network and computing infrastructure. Although there are numerous techniques and cyber-threat detection systems currently being used to detect and purge viruses and malicious code, they fail to guard against all cyber-threats, and are especially ill-equipped at defending against zero-day attacks, which exploit previously unknown software vulnerabilities.

Most existing perimeter cyber-threat detection systems inspect incoming traffic using malware definitions and heuristic algorithms. While these systems—when kept up-to-date—can be efficient and effective, the current malware-detection paradigm contains certain intrinsic weaknesses: (1) Window of Vulnerability: No matter how quickly anti-malware vendors a) discover a threat, b) develop signatures to detect the threat, and c) release the update, there is always a window of vulnerability before the threat is discovered; (2) Custom attacks: Existing detection systems relying upon signature-based detection identify security threats by scanning files for certain byte sequences that match known patterns or previously identified malicious code. In contrast, custom attacks are designed to target a specific individual or organization and are therefore likely to be zero-day attacks, which take advantage of the window of vulnerability to evade detection; and (3) Infected Systems: Many detection systems are installed and run locally on a user's system. If the user's system is already infected, the detection system itself may be compromised, potentially rendering the detection system unreliable and ineffective.

These weaknesses allow undetected malware to cross the network perimeter, and, in some cases, reach the end user's system. Such threats include undetected malicious files (e.g., email-borne viruses) as well as links to web pages that contain malicious code. An email containing a link to a malicious web page does not itself contain dangerous code, and it can thus easily bypass detection; only when a user clicks it and loads the page does the malicious code launch. A link sent to a user may also seek to deceive a user into providing personal information, such as login credentials or personal account numbers, by pretending to be sent from a legitimate source. Automated detection of such illicit solicitation attempts, commonly known as phishing, is particularly difficult because such attempts don't contain any inherently malicious code. Once a threat reaches an end user, the integrity of the network depends on factors local to that specific user, such as user permissions, installed vulnerability patches, real-time protection, and, of course, user training and judgment. At present, system administrators are commonly only alerted to the presence of suspicious files or links by users receiving such files. The system administrator may then proceed to execute such file or link manually in an environment isolated from their network resources, manually observing the results, and trying on a case by case basis to make a determination as to whether or not the file or link is malicious based on the results of this test. This practice, followed by system administrators as a best practice, places increasing demands on limited IT staff time and still leaves the decision to the user receiving such file or link as to whether to contact the system administrator, or take their chances that the file will not be malicious.

The present disclosure addresses these weaknesses.

### SUMMARY

In one aspect the present disclosure relates to methods and systems that allow for systematic and automatic detection of cyber-based threats.

In particular, the present disclosure relates to computer-implemented methods of executing and monitoring content within a secure isolated environment to detect cyber-based threats. One embodiment of the methods includes the steps of locating and identifying content for execution and monitoring within a secure isolated environment; preparing the located and identified content by separating the content into its individual components; processing each individual component by executing each individual component within the secure isolated environment; monitoring and recording system activity at the kernel, network and application levels resulting from the execution of the individual component; processing the recorded system activity to identify malicious behavior; and reporting the results of the processing to a client system or user.

In one embodiment, a client component is configured to systematically scan an organization's network to locate and identify content for execution and monitoring within the secure isolated environment. This embodiment would allow an organization to identify malicious files that are already resident on the organization's system. In another embodiment, a client component is configured to intercept unprocessed content introduced via one or more attack vectors before the unprocessed content is delivered to the end user. In one embodiment of this approach, client components would include those that intercept code introduced via the potential attack vectors of email or peripheral devices (e.g., USB thumb drive, Bluetooth devices, external hard drive, etc.).

In one embodiment, the described secure isolated environment is a virtual machine environment.

In another embodiment, the described secure isolated environment is one of a plurality of virtual machine environments.

In another embodiment, the described system activity monitoring is carried out by one or more modules injected into one or more application operating systems installed on the secure isolated environment. In yet another embodiment, the processing of each individual component further includes examining the component for the presence of any illicit solicitation attempts.

The present disclosure also relates to a cyber-threat detection system having one or more processors configured to execute and monitor content intercepted by one or more client components, each guarding against one or more potential attack vectors, within a secure isolated environment wherein the secure isolated environment is configured to monitor kernel, network and application level system activity resulting from the execution of the intercepted content in the secure isolated environment, process the results of the recorded system activity to identify malicious behavior and report the results of the processing to the client components or a user.

In one embodiment of the disclosed system, a client component is configured to systematically scan an organization's network to locate and identify content for execution and monitoring within the secure isolated environment. In another embodiment, one or more client components are configured to intercept unprocessed content introduced via one or more attack vectors before the unprocessed content is delivered to the end user. In one embodiment of this system, client components would include those that intercept code introduced via the potential attack vectors of email, mobile devices or attached peripheral devices (e.g., USB thumb drive, external hard drive, etc.).

In one embodiment of the disclosed system, the secure isolated environment is a virtual machine environment.

In another embodiment, the secure isolated environment is one of a plurality of virtual machine environments.

In another embodiment of the disclosed system, the described system activity monitoring is carried out by one or more modules injected into one or more application operating systems installed on the secure isolated environment. In yet another embodiment, the secure isolated environment is further configured to examine intercepted content for the presence of any illicit solicitation attempts.

### BRIEF DESCRIPTION OF THE FIGURES

The features of the various embodiments are set forth with particularity in the appended claims. The advantages of the various embodiments described herein, together with further advantages, may be better understood by referring to the following description taken in conjunction with the accompanying figures. In the figures, like reference characters generally refer to the same components throughout the different figures. The figures are not necessarily to scale, emphasis instead generally being placed upon illustrating the principles of the various embodiments.

FIG. 1A depicts a partial view of a flow diagram showing a portion of an illustrative process of a cyber-threat detection system and method for conducting cyber-threat detection operations, according to a disclosed embodiment.

FIG. 1B depicts a partial view of the flow diagram shown in FIG. 1A showing another portion of an illustrative process of a cyber-threat detection system and method for conducting cyber-threat detection operations, according to a disclosed embodiment.

FIG. 2 depicts a flow diagram showing an illustrative process by which an email client operates within the cyber-threat detection system according to a disclosed embodiment.

FIG. 3 depicts a flow diagram showing an illustrative process by which a secure isolated environment operates to perform system activity monitoring according to a disclosed embodiment.

FIG. 4 depicts a flow diagram showing an illustrative process by which illicit solicitations can be detected according to a disclosed embodiment.

### DETAILED DESCRIPTION

The terms “a,” “an,” “the” and similar referents used in the context of describing the disclosure (especially in the context of the following claims) are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it were individually recited herein. All methods disclosed herein can be performed in any suitable order unless otherwise indicated herein or otherwise clearly contradicted by context. The use of any and all examples, or exemplary language (e.g., “such as”) provided herein is intended merely to better illuminate the invention and does not pose a limitation on the scope of the invention otherwise claimed. No language in the specification should be construed as indicating any non-claimed element essential to the practice of the invention.

The systems and methods of the present disclosure relate to a scalable cyber-threat detection system that systematically and automatically executes and monitors code within a secure isolated environment to automatically identify and filter out malicious code so that it is not executed on an end user's system.

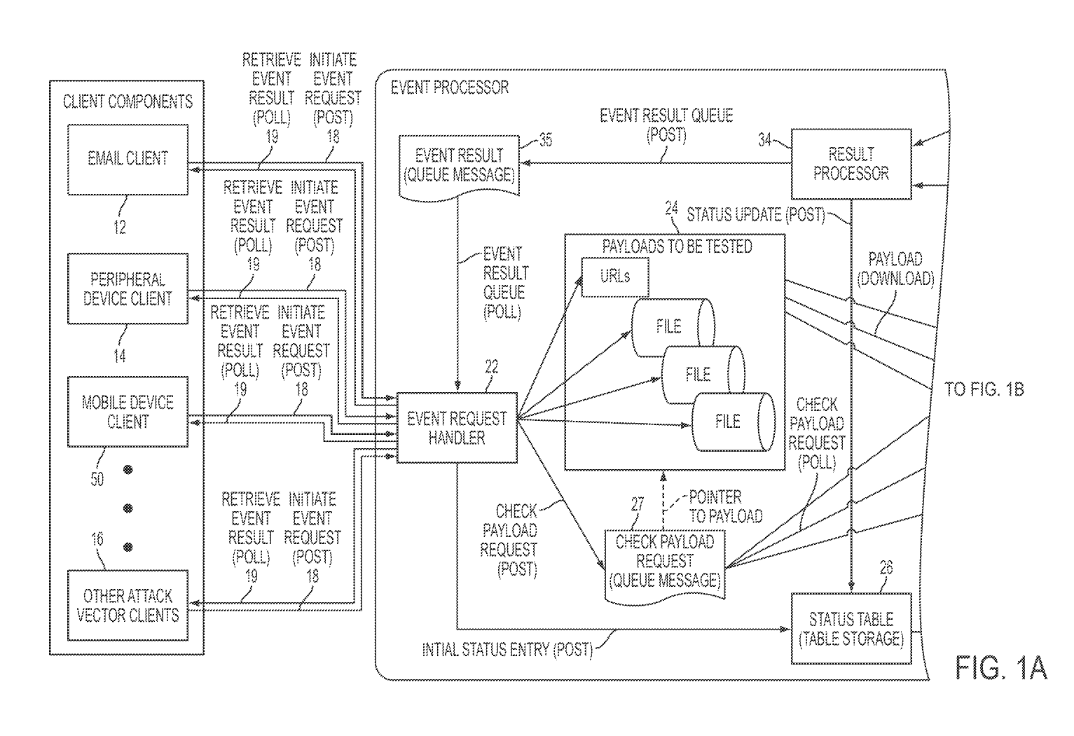

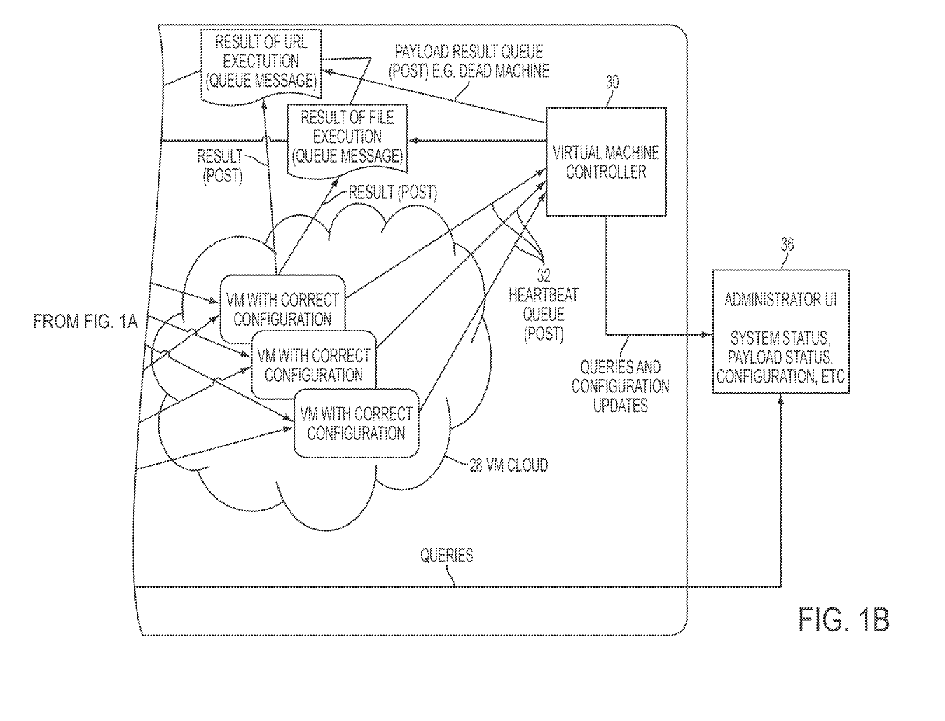

FIGS. 1A-B illustrate the steps that are carried out in one embodiment of the method for cyber-threat detection to identify malicious code by executing the malicious code in a secure virtual-machine environment that is isolated from a user system in order to detect the existence or non-existence of malicious actions with no adverse effects on the user system. In this embodiment, Client Components 10 represent the interface point between each potential attack vector, such as an Email Client 12, a Peripheral Device Client 14 or a Mobile Device Client 50 and the Event Processor 20. The Client Components 10 can perform a number of roles each tailored to one or more particular attack vectors. Each Client Component 10 can intercept a particular event such as receiving an email, inserting a USB drive, or receiving content on a mobile device (e.g. via a mobile application, MMS) and generate an Event Request 18 for that event. Each Event Request 18 can contain one or more Uniform Resource Indicators (“URIs”) or files (collectively, “Payloads”) to be processed by the Event Processor 20. Each Client Component 10 can be responsible for tracking and assembling Event Results 19 to handle its particular events. In some embodiments of the Client Components 10, each Client Component 10 could decide to disallow an intercepted event if the processing results indicated that the event included malicious content or could route the content to a quarantine location for further analysis by an authorized user, such as a system administrator. In another embodiment, each Event Result 19 could include a reference that would allow the handling Client Component 10 to present the end user the option of executing suspicious content within a secure isolated environment to observe any potentially malicious behavior. In this embodiment, application virtualization, or another method of remote application access, could be employed to allow an end user to safely observe the execution of the content from the end user's system, while ensuring that the actual execution of the content remains confined to the secure isolated environment.

After constructing an Event Request 18, the Client Component 10 can send the Event Request 18 to the Event Processor 20, which initiates the process of checking the associated Payload(s) for malicious code. Each Client Component 10 can also regularly query the Event Processor 20 for Event Results 19. In this embodiment, Client Components 10 examine the Event Results 19 to determine if a particular event contains a suspect action, and can then take appropriate action, such as denying a requested action or routing a Payload to a location for further inspection by a user.

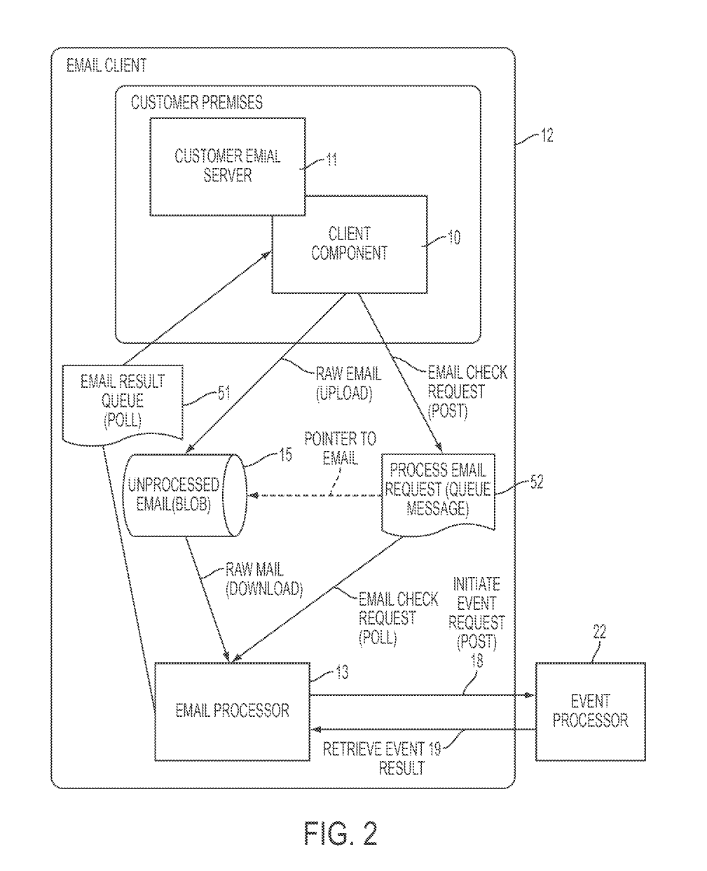

The flowchart of FIG. 2 illustrates one embodiment of the steps by which an email is dispatched to the Event Request Handler 22 for processing by the Event Processor 20. In this embodiment, the Email Client 12 intercepts potentially malicious code entering through a particular attack vector: email. The Email Client 12 includes the Client Component 10, which interfaces with the Customer Email Server 11, both of which in this embodiment are located on the customer premises. The Customer Email Server 11 dispatches incoming unprocessed emails to the Client Component 10, which uploads them to an Unprocessed Email Container 15 and creates request messages corresponding to the unprocessed emails in the Email Request Queue 52. An Email Processor 13 can then check for a request message in the Email Request Queue 52 and download the associated unprocessed raw email from the Unprocessed Email Container 15. The Email Processor 13 then scans the email and extracts components of the email for processing. The Email Processor 13 then initiates an Event Request 18 which is sent on to the Event Request Handler 22. The Email Processor 13 also polls the Event Request Handler 22 to retrieve the results from processed emails. The Email Processor 13 then posts a message indicating whether the email contains malicious code to the Email Result Queue 51. The Client Component 10 retrieves messages from the Email Result Queue 51 and routes the associated email based on the results: clean emails can be queued for normal delivery by the Customer Email Server 11 and malicious emails can be flagged as quarantined for later inspection and analysis by a system administrator.

In one embodiment, the Email Processor 13 parses the text of emails looking for patterns that would indicate a link, whether expressed as using traditional hypertext mark-up language (HTML) anchored links or links not expressed as traditional HTML hyperlinks. Often, malicious emails will paste a non-traditional text link within the body text with instructions for the receiver to manually copy and paste the link to a browser. In addition, most modern email clients generally parse the plain text of an email, looking for strings that may be a link to an external (or internal) resource. These clients then present this text as a link, which while not necessarily an explicit link, will be identified and treated as such by these clients. The Email Processor 13 parsing described above ensures that the system blocks these vectors.

Returning to FIGS. 1A-B, in this embodiment, the Event Processor 20 receives Event Requests 18 from one or more Client Components 10, unpacks all of the Payloads associated with a given Event Request 18, executes each Payload in a separate virtual machine environment, monitors the execution of the Payload and analyzes the results to determine if a given Payload is malicious. The Event Processor 20 can also track the results for each Payload associated with a given Event Request 18 and then assemble and queue the Event Result 19 for a particular Client Component 10 once the processing of all Payloads associated with the Event Request 18 is complete.

In this embodiment, the Event Processor 20 includes an Event Request Handler 22. The Event Request Handler 22 can inspect Event Requests 18, identify and unpack the associated Payloads into separate Payload requests and generate and route the individual Payload requests to the Storage System 24 as well as query the Event Result Queue 35 for information relating to completed Payload testing. The Storage System 24 is used to store all payloads and is used as the transitory store for moving content between various parts of the Event Processor 20. Each Payload request contains one Payload along with associated metadata for tracking and routing the Payload. An example of one such metadata item is a correlation token, which identifies the Event Request 18 with which the Payload is associated. In one embodiment of the Storage System 24, each Payload is saved to either table storage (for URIs) or blob storage (for files) within the Storage System 24. When the Event Request Handler 22 uploads a Payload, it creates an entry in the Status Table 26 to indicate that the Payload has been received, and queues a work item to the Check Payload Request Queue 27. Each work item contains a reference to its associated Payload. Each entry in the Status Table 26 includes metadata associated with an Event Request 18, hash values to uniquely identify the Event Request's 18 content and the current processes which are handling the Event Request 18.

In one embodiment, the Isolated Execution Cloud 28 is a pool of two or more VMs that are ready and available to process Payloads saved within the Storage System 24. Each VM within the Isolated Execution Cloud 28 has a component which polls the Check Payload Request Queue 27 for work items needing processing. When a work item is present, the VM downloads the associated Payload and executes it in the local context, capturing kernel, network and application level activity. Once execution is complete, the captured activity is sent in a message posted to the Payload Result Queue 31. In this embodiment, each VM within the Isolated Execution Cloud 28 executes a single Payload at a time.

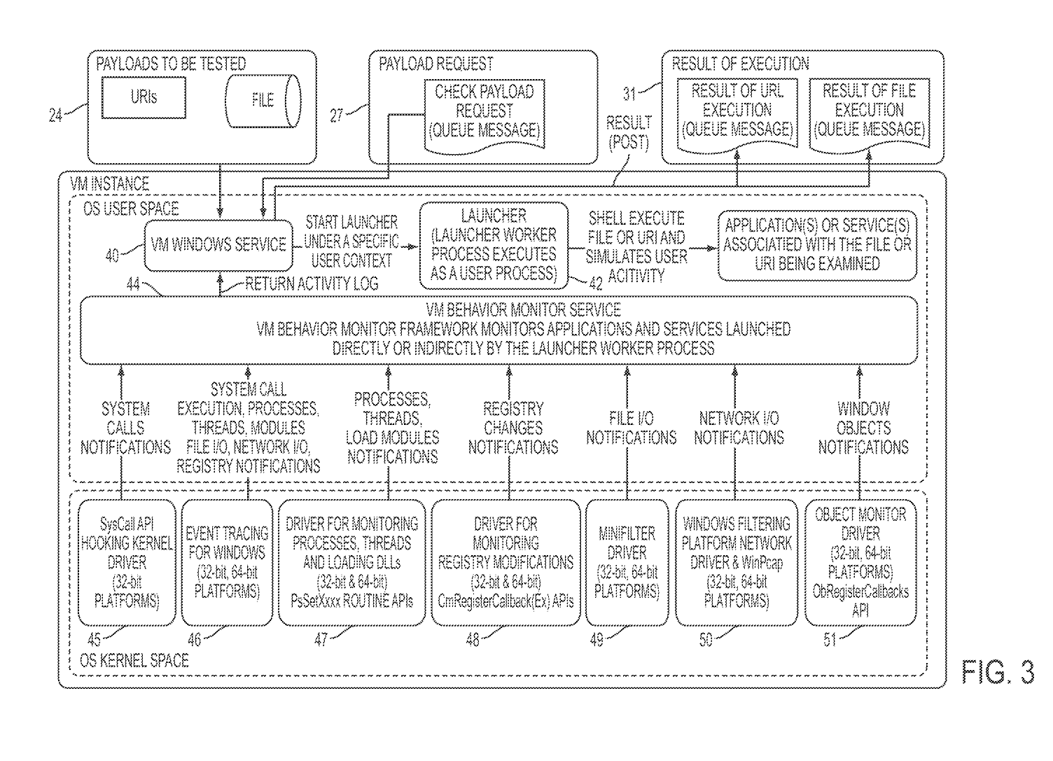

The flowchart of FIG. 3 further illustrates one embodiment of the process by which the VMs within the Isolated Execution Cloud 28 process Payloads saved within the Storage System 24. In this embodiment and as discussed above, each VM within the Isolated Execution Cloud 28 queries the Check Payload Request Queue 27 for work items and downloads the associated Payloads to be processed from the Storage System 24. In one embodiment, the VMs are configured to run and monitor system activity on the Microsoft Windows operating system. In this embodiment, once a Payload has been downloaded to the VM, the VM Windows Service 40 starts an instance of the Launcher 42 under a specified user security context and running within a local or remote user session. VM Windows Service 40 directs the Launcher 42 to launch an application or service configured to open the Payload being examined. For instance, where the Payload is a Microsoft Word (Microsoft Corporation, Redmond, Wash.) document, the VM Windows Service 40 starts the Launcher 42 under a specific user account and session and directs the Launcher 42 to open an instance of Microsoft Word on the VM operating system to simulate user activity. Where the Payload is a HTML hyperlink, the Launcher 42 opens an instance of an internet browser on the VM operating system. Respectively, where the Payload is a binary executable, the VM Windows Service 40 instructs the Launcher 42 to execute the specified binary payload. In another embodiment, each Payload is processed by multiple VMs, each configured with different combinations of operating systems, web browsers and applications. For example, a link could be evaluated for malicious behavior on both Internet Explorer (Microsoft Corporation, Redmond, Wash.) and Firefox (Mozilla Corporation, Mountain View, Calif.).

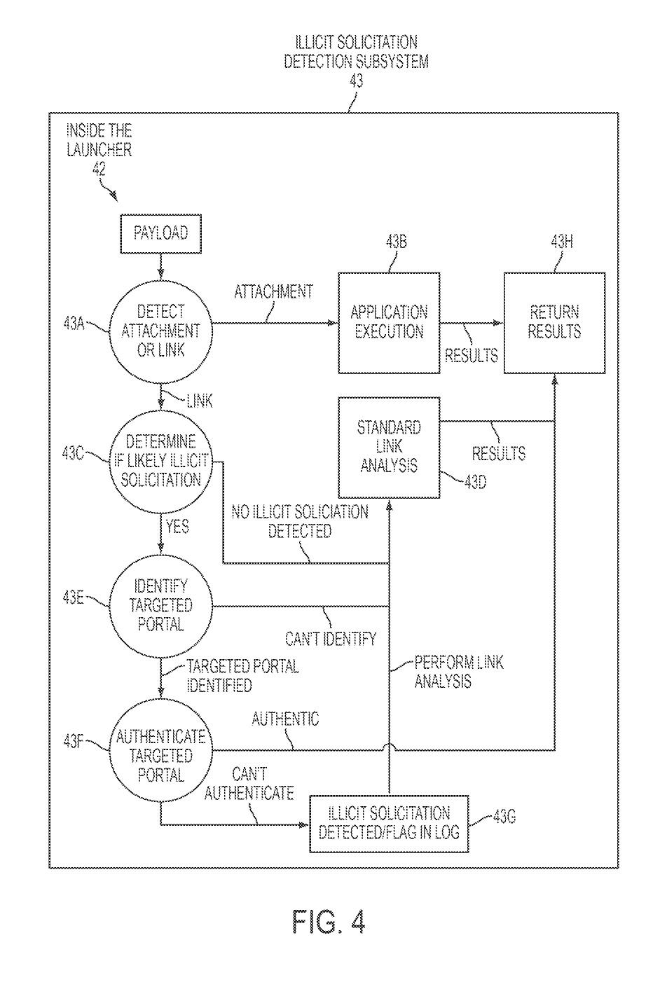

The flowchart of FIG. 4 illustrates one embodiment of the processes by which the Launcher 42 (FIG. 3) examines Payloads. Within the Launcher 42 (FIG. 3) is an Illicit Solicitation Detection Subsystem 43 that evaluates Payloads for any attempts to illicitly acquire information from a user, such as phishing attacks. Once the VM Windows Service 40 (FIG. 3) starts an instance of the Launcher 42 (FIG. 3) to launch a Payload, the Illicit Solicitation Detection Subsystem 43 first 43A determines if the Payload is a link or an attachment. If the Payload is an attachment, the attachment is executed as described within the present disclosure.

If the Payload is a link, either traditional or non-traditional, the Payload is subjected to one or more tests 43C to detect the presence of a potential illicit solicitation attempt, such as an attempt to collect user information as part of a phishing attack. In some embodiments, the tests that are conducted to detect the presence of a potential illicit solicitation attempt include, without limitation, searching for potential user input forms, mechanism for submitting data, etc.

Where the tests 43C fail to detect any illicit solicitation attempts, the Illicit Solicitation Detection Subsystem 43 sends for standard link analysis 43D as described within the present disclosure.

Where the tests 43C determine that the link poses a risk of illicit solicitation the Illicit Solicitation Detection Subsystem 43 attempts to identify a target portal for the attack 43E, such as a login page for a well-known service that a phishing attack may be attempting to spoof. In one embodiment, portal identification is achieved by performing an image difference between a screenshot of the subject page against a repository of screenshots of known portals. Where a target portal cannot be identified, the Illicit Solicitation Detection Subsystem 43 sends the link for standard link analysis 43D as described within the present disclosure.

Where the Illicit Solicitation Detection Subsystem 43 identifies a target portal for the attack, the link is presented and compared against known aspects of the targets portal 43F in an effort to authenticate the targeted portal. In some embodiments, these known aspects include, without limitation, login page and IP address of the target portal, encrypted token known only to the detection system and target portal, etc.

If the target portal cannot be authenticated after comparisons of the link against known aspects of the target portal 43F, the link is flagged 43G as a potential illicit solicitation attempt. The Illicit Solicitation Detection Subsystem 43 then sends the flagged link for standard link analysis 43D as described within the present disclosure. Where the target portal is deemed authentic, the link is flagged accordingly, the Payload is green-lighted for delivery and the results are reported 43H as described within the present disclosure.

Returning to FIG. 3, while the Launcher 42 is executing the Payload, the VM Behavior Monitor Framework 44 monitors and records all applications and services launched directly or indirectly by the VM Windows Service 40 and Launcher 42. Once the Payload launch is completed, any applications launched to execute the Payload are closed within the VM and the recorded activity is posted in a message to the Payload Result Queue 31.

In this embodiment, the VM Behavior Monitor Framework 44 monitors the launch and execution of the Payload from the VM, capturing kernel, network and application level activity. Many existing perimeter cyber-threat detection systems work by attempting to discern whether a file will exhibit malicious behavior from the appearance or contents of the malicious file. The present disclosure differs in that the VM Behavior Monitor Framework 44 integrates with the operating system process that would be affected by the malicious code. In addition, unlike most host cyber-threat detection systems which operate with a multitude of running applications and services, the disclosed system and method works within a VM environment that runs and monitors only the applications and services necessary to execute/launch the Payload under investigation. By running and monitoring only the applications and services relevant to the Payload, the present disclosure is able to ascertain the activity directly attributable to the execution/launching of the Payload without contaminating the activity log with irrelevant information related to other processes running within the VM environment.

In one embodiment, the VM Behavior Monitor Framework 44 operates in both kernel mode and user mode where any and all actions resulting from the execution/launching of the Payload are observed during the execution of the Payload. In some embodiments, the VM Behavior Monitor Framework 44 targets the Microsoft Windows operating system and is hosted by the VM Behavior Monitor Windows Service. The VM Behavior Monitor Framework 44 may consist of SysCall API Hooking Kernel driver 45, Event Tracing for Windows 46, Driver for Monitoring Processes, Threads and Loading DLLs 47, Driver for Monitoring Registry Modifications 48, Minifilter Driver 49, Windows Filtering Platform Network Driver & WinPcap 50 and Object Monitor Driver 51. SysCall API Hooking Kernel driver (KernelProtect) 45 may be configured to hook critical native APIs and provide a highly efficient mechanism for intercepting, analyzing and optionally blocking unwanted API execution for 32-bit Windows platforms. The SysCall API Hooking Kernel driver (KernelProtect) 45 may support 32-bit platforms only as it requires hooking of SDT kernel structure. All other kernel components (46 —51) described below, run at kernel level and may provide full support for both 32-bit and 64-bit platforms. The components (46 —51) are compatible with Microsoft PatchGuard. Event Tracing for Windows 46 is a built-in Windows kernel infrastructure that exposes kernel events through the NT Kernel Logger trace session. The NT Kernel Logger trace session generates a trace of Windows kernel events in real time that are consumed by VM Behavior Monitor Service 44. Event Tracing for Windows 46 enables tracing of native API execution (SysCalls), process, thread, loading modules (DLLs), physical disk & file I/Os, registry changes, TCP/IP and many other events. The driver for Monitoring Processes, Threads and Loading DLLs (PsSetXxxx routines) 47 allows intercepting of events like process creation/termination, creating threads, and load modules. For 64-bit platforms where Microsoft PatchGuard prevents drivers from hooking the SDT kernel structure, all registry changes may be monitored through Driver for Monitoring Registry Modifications 48. The Driver for Monitoring Registry Modifications 48 filters all registry calls. The Minifilter Driver 49 is a file I/O filter driver that captures file I/O activity. Windows Filtering Platform Network Driver & WinPcap 50 is a set of kernel components responsible for capturing TCP/IP network traffic. The Network Driver and Packet Capturing (pcap) component 50 allows intercepting and analyzing all network traffic as well as the ability to block unwanted inbound and outbound I/O operations. Object Monitor Driver 51 is a kernel driver whose goal is to detect the creation and duplication of Windows handles. In one embodiment, all monitoring components may be designed to run in kernel mode to ensure capturing the execution of any code and address known issues with bypassing user mode detection and API user mode hooking code. This transparent binary integration with the core operating system components allows for uninterrupted API and network activity detection of any and all activity and behavior as opposed to detection by observing side effects.

All monitoring components of the VM Behavior Monitor Framework 44 operate inside an uncompromised VM environment and are fully trusted by the operating system. As a result, the VM Behavior Monitor Framework 44 establishes a static trusted baseline with the operating system and can detect any potentially malicious behavior. This technique ensures that all filters installed by the VM Behavior Monitor Framework 44 are called first before any other filters. There is no need to try eliminating any race with Rootkits or Malware as the system is clean and uncompromised. Following an execution, the VM can be destroyed and recreated from a clean image to reestablish this static trusted baseline.

The cyber-threat detection systems and methods disclosed herein are not limited to detecting malicious code designed to compromise the VM operating system. While malicious code most commonly attempts to compromise the operating system, the disclosed method may also filter any and all APIs which could allow a Payload to execute malicious code or infect “read-only” applications such as Adobe Reader® (Adobe Systems, Inc., San Jose, Calif.), Firefox (Mozilla Corporation, Mountain View, Calif.) or Skype™ (Microsoft Corporation, Redmond, Wash.). In addition, the VM Behavior Monitor Framework 44 of the present disclosure operates at kernel level, monitoring based on binary interception allowing for a unified functional solution for 32-bit, 64-bit and future platforms, including 128-bit.

The VM Behavior Monitor Framework 44 runs as a separate Windows Service process. The VM Behavior Monitor Framework 44 collects in real time information about the behavior of all processes that run within the operating system, including any code executing in kernel mode. For older 32-bit Windows versions (e.g., Windows XP, 2003), the VM Behavior Monitor Framework 44 utilizes a kernel level driver to intercept in real time execution of the native Windows APIs by modifying the SDT kernel structure. For more recent 32-bit platforms and all 64-bit Windows versions, the VM Behavior Monitor Framework 44 utilizes Event Tracing for Windows 46, Driver for Monitoring Processes, Threads and Loading DLLs 47, Driver for Monitoring Registry Modifications 48, Minifilter Driver 49, Windows Filtering Platform Network Driver & WinPcap 50, and Object Monitor Driver 51 to capture any critical kernel level code execution. The VM Behavior Monitor Framework 44 collects the activity log and returns the log to the VM Windows Service 40. Each activity log consists of a set of entries each of which describe in detail a specific operation or activity that took place while executing the Payload. Details about execution of native APIs, registry modifications, file I/O activity and network traffic resulting from Payload execution are recorded by the VM Behavior Monitor Framework 44 in the activity log.

Returning again to FIGS. 1A-B, in one embodiment of the method for cyber-threat detection, the VMs in the Isolated Execution Cloud 28 send status messages to the Virtual Machine Controller 30 via a Heartbeat Queue 32. The status messages are sent when a Payload is about to be processed and periodically during the execution process. This allows the Virtual Machine Controller 30 to know that the processing VM is still alive and active. Since executing malicious code could cause the VM to crash and fail to generate a record of the monitored activity, the Heartbeat Queue 32 allows the Virtual Machine Controller 30 to stay up to date with the status of the Payload execution activity, and take action if a VM has crashed.

The Virtual Machine Controller 30 is the component that manages the VMs in the Isolated Execution Cloud 28. VMs are created or destroyed based on factors such as overall load on the system, transitory failures of machines within the Isolated Execution Cloud 28, and VMs that have stopped running due to illegal operations performed by launched Payloads. If a particular Payload causes the VM to lose the heartbeat, the Virtual Machine Controller 30 considers the Payload malicious and sends a message to the Payload Result Queue 31 with that information.

Once the Payload execution is completed as described in FIG. 3 above, the monitored activity that the VM Behavior Monitor Framework 44 captured is posted in a message to the Payload Result Queue 31 along with any associated Payload-related messages sent from the Virtual Machine Controller 30.

A Result Processor 34 polls the Payload Result Queue 31 to retrieve activity logs for processing and updates the Status Table 26 with information retrieved from the Payload Result Queue 31. The Result Processor 34 analyzes the activity log to determine the existence of malicious behavior by running the entries in the activity log through a set of rules. In one embodiment, the rules in the Result Processor 34 contain sets of valid and malicious actions specific to particular operating systems, applications and versions of applications. When updating the Status Table 26, if all elements with a given correlation token are in a finished state (clean, suspect or malicious), then a message is sent to the Event Result Queue 35 containing the processing results indicating whether the content was malicious.

A loss of heartbeat from a VM does not always mean that the Payload it was executing is malicious. It could be that the VM system crashed due to a failure unrelated to the Payload. In some embodiments, the Result Processor 34 can determine that the Payload launch results were indeterminate (e.g. by reading a message sent by the Virtual Machine Controller 30 reporting a lost heartbeat) and cause the Payload to be recycled through the system. In some embodiments an upper threshold for recycle attempts can be set after which the Payload is considered malicious despite repeated indeterminate results.

Throughout the operation of the Event Processor 20, an Administrative User Interface 36 is accessible to users. In this embodiment, the Administrative User Interface 36 is an application through which a user can monitor the status of the system as a whole, monitor particular Payloads within the system, and configure the system. Configuration of the system includes, without limitation, selection of supported operating systems, particular applications and versions of those applications to test on, number of virtual machines to be used, configuration routing information, rules for handling indeterminate results and other actions.

Groupings of alternative elements or embodiments of the present disclosure are not to be construed as limitations. Each group member may be referred to and claimed individually or in any combination with other members of the group or other elements found herein. It is anticipated that one or more members of a group may be included in, or deleted from, a group for reasons of convenience. When any such inclusion or deletion occurs, the specification is deemed to contain the group as modified thus fulfilling the written description of all Markush groups used in the appended claims.

It is to be understood that the various embodiments disclosed herein are illustrative of the principles of the present disclosure. Other modifications that may be employed are within the scope of the appended claims. Thus, by way of example, but not of limitation, alternative configurations of the various embodiments may be utilized in accordance with the teachings herein. Accordingly, the appended claims are not limited to the embodiments precisely as shown and described.

Various embodiments may be described herein in the general context of computer executable instructions, such as software, program modules, and/or engines being executed by a computer. Generally, software, program modules, and/or engines include any software element arranged to perform particular operations or implement particular abstract data types. Software, program modules, and/or engines can include routines, programs, objects, components, data structures and the like that perform particular tasks or implement particular abstract data types. An implementation of the software, program modules, and/or engines components and techniques may be stored on and/or transmitted across some form of computer-readable media. In this regard, computer-readable media can be any available medium or media useable to store information and accessible by a computing device. Some embodiments also may be practiced in distributed computing environments where operations are performed by one or more remote processing devices that are linked through a communications network. In a distributed computing environment, software, program modules, and/or engines may be located in both local and remote computer storage media including memory storage devices.

Although some embodiments may be illustrated and described as comprising functional components, software, engines, and/or modules performing various operations, it can be appreciated that such components or modules may be implemented by one or more hardware components, software components, and/or combination thereof. The functional components, software, engines, and/or modules may be implemented, for example, by logic (e.g., instructions, data, and/or code) to be executed by a logic device (e.g., processor). Such logic may be stored internally or externally to a logic device on one or more types of computer-readable storage media. In other embodiments, the functional components such as software, engines, and/or modules may be implemented by hardware elements that may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth.

Examples of software, engines, and/or modules may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

Reference throughout the specification to “various embodiments,” “some embodiments,” “one example embodiment,” or “an embodiment” means that a particular feature, structure, or characteristic described in connection with the embodiment is included in at least one example embodiment. Thus, appearances of the phrases “in various embodiments,” “in some embodiments,” “in one example embodiment,” or “in an embodiment” in places throughout the specification are not necessarily all referring to the same embodiment. Furthermore, the particular features, structures, or characteristics illustrated or described in connection with one example embodiment may be combined, in whole or in part, with features, structures, or characteristics of one or more other embodiments without limitation.

While various embodiments herein have been illustrated by description of several embodiments and while the illustrative embodiments have been described in considerable detail, it is not the intention of the applicant to restrict or in any way limit the scope of the appended claims to such detail. Additional advantages and modifications may readily appear to those skilled in the art.

It is to be understood that at least some of the figures and descriptions herein have been simplified to illustrate elements that are relevant for a clear understanding of the disclosure, while eliminating, for purposes of clarity, other elements. Those of ordinary skill in the art will recognize, however, that these and other elements may be desirable. However, because such elements are well known in the art, and because they do not facilitate a better understanding of the disclosure, a discussion of such elements is not provided herein.

While several embodiments have been described, it should be apparent, however, that various modifications, alterations and adaptations to those embodiments may occur to persons skilled in the art with the attainment of some or all of the advantages of the disclosure. For example, according to various embodiments, a single component may be replaced by multiple components, and multiple components may be replaced by a single component, to perform a given function or functions. This application is therefore intended to cover all such modifications, alterations and adaptations without departing from the scope and spirit of the disclosure as defined by the appended claims.

What is claimed is:

1. A computer-implemented method of executing content within a secure isolated environment, monitoring and recording the execution of the content, and processing the recorded results of the execution to detect and filter out cyber-based threats, the method comprising the steps of:
locating and identifying content for execution and monitoring within a unique secure isolated environment, the unique secure isolated environment comprising a computer including a processor configured to execute computer readable instructions;
preparing the located and identified content for execution and monitoring by separating the content into individual components;
processing each individual component by executing each individual component within the unique secure isolated environment;
monitoring and recording system activity resulting from the execution of each individual component within the unique secure isolated environment;
processing the recorded system activity from each of the components to identify whether the located and identified content is a threat; and
reporting the processing results.

2. The computer-implemented method according to claim 1 wherein one or more client components are configured to locate and identify the content for execution and monitoring within the unique secure isolated environment.

3. The computer-implemented method according to claim 2, wherein at least one client component is configured to systematically scan a network to locate and identify resident files for execution and monitoring within the unique secure isolated environment.

4. The computer-implemented method according to claim 2, wherein one or more client components are configured to intercept unprocessed content introduced via one or more attack vectors before the unprocessed content is delivered to the end user.

5. The computer-implemented method according to claim 4, wherein the attack vectors comprise email, mobile devices and attached peripheral devices.

6. The computer-implemented method according to claim 1, wherein the unique secure isolated environment is a virtual machine environment.

7. The computer-implemented method according to claim 1, wherein the unique secure isolated environment is one of a plurality of virtual machine environments.

8. The computer-implemented method according to claim 1, wherein the monitored and recorded system activity is captured at a kernel level, a network level and an application level.

9. The computer-implemented method according to claim 8, wherein the monitoring of system activity at the kernel, network and application levels is carried out by one or more modules integrated with one or more application operating systems installed on the unique secure isolated environment.

10. The computer-implemented method according to claim 1, wherein the processing of each individual component further comprises examining each individual component for the presence of any illicit solicitation attempts.

11. A cyber-threat detection system comprising:
one or more processors configured to execute and monitor content located and identified by one or more client components within a unique secure isolated environment, wherein the unique secure isolated environment is configured to monitor and record system activity resulting from the execution of the located and identified content in the unique secure isolated environment, process the results of the recorded system activity to identify threats and report the results of the processing to the client components or a user.

12. The cyber-threat detection system according to claim 11, wherein at least one client component is configured to systematically scan a network to locate and identify resident files for execution and monitoring within the unique secure isolated environment.

13. The cyber-threat detection system according to claim 11, wherein one or more client components are configured to intercept unprocessed content introduced via one or more attack vectors before the unprocessed content is delivered to the end user.

14. The cyber-threat detection system according to claim 13, wherein the one or more attack vectors comprise email, mobile devices and attached peripheral devices.

15. The cyber-threat detection system according to claim 11, wherein the unique secure isolated environment is a virtual machine environment.

16. The cyber-threat detection system according to claim 11, wherein the unique secure isolated environment is one of a plurality of virtual machine environments

17. The cyber-threat detection system according to claim 11, wherein the monitored and recorded system activity is captured at a kernel level, a network level and an application level.

18. The cyber-threat detection system according to claim 17, wherein the monitoring of system activity at the kernel, network and application levels is carried out by one or more modules integrated with one or more application operating systems installed on the unique secure isolated environment.

19. The cyber-threat detection system according to claim 11, wherein the unique secure isolated environment is further configured to examine located and identified content for the presence of any illicit solicitation attempts.
